(19) United States
(12) Patent Application Publication
(10) Pub. No.: US 2006/0152179 A1
(43) Pub. Date: Jul. 13, 2006

(54) Transmission-controlling device

(75) Inventor: Yen-Chih Chang, Taichung Hsien (TW)

Correspondence Address: BACON & THOMAS, PLLC, 625 SLATERS LANE, FOURTH FLOOR, ALEXANDRIA, VA, 22314, US

(73) Assignee: REXON INDUSTRIAL CORPORATION LTD., TAICHUNG HSIEN (TW)

(21) Appl. No.: 11/298,537

(22) Filed: Dec. 12, 2005

(30) Foreign Application Priority Data
Dec. 13, 2004 (TW) 93220001
Aug. 8, 2005 (TW) 94126810
Dec. 8, 2005 (TW) 94143407

(51) Int. Cl. H02P 5/00

(52) U.S. Cl. 318/109

(57) ABSTRACT

A transmission-controlling device includes a first circuit system, a second circuit system, and a selective switch. The first circuit system is to provide a first voltage. The second circuit system is to provide a second voltage. The selective switch responds to a user's operation to select the first or second voltage to drive the motor so as to change the rotational speed of the motor. The motor is adapted to a power tool and rotates a cutting blade of said power tool to process a workpiece. Thus, the present invention employs the selective switch to select the driving voltage for the motor to simplify and facilitate the switchover of the rotational speed of the motor.

### BACKGROUND OF THE INVENTION

1. Field of the Invention

The present invention relates to a motor driving a cutting blade of a power tool, and more particularly, to a transmission-controlling device for changing the rotational speed of the motor.

2. Description of the Related Art

A conventional power tool, such as a circular saw machine or a drilling machine among the woodworking machines, is working by that a motor runs to drive a cutting blade to cut or drill a workpiece. However, the workpiece can be diversified in type and material such that the rotational speed of the motor has to be adjusted according to the material characteristics of the workpiece, while the workpiece is cut or drilled, to enable the cutting blade to cut or drill the workpiece with optimal working efficiency.

To meet the requirement of adjusting the rotational speed of the motor, there are a variety of techniques of controlling the rotational speed. Among the techniques, for example, one is to control the input power of a coil of the motor to adjust the rotational speed, and another is to tune the pulse breadth of an alternate current (AC) power source driving the motor. However, some power tools usually merely process the workpieces made of a minority of specific kinds of materials. For example, a woodworking machine requires only two or three different velocities for the change of the rotational speed, such that conventional transmission-controlling devices are too complicated for such woodworking machine and increase the cost.

### SUMMARY OF THE INVENTION

The primary objective of the present invention is to provide a transmission-controlling device for driving a motor to improve the drawback of the prior art. The transmission-controlling device is to adjust the rotational speed of a motor applied to a power tool to rotate a cutting blade mounted to the power tool to process a workpiece. The transmission-controlling device further provides the user with operational convenience of facilitating the switchover between two kinds of circuit systems for simple switchover of the rotational speed of the motor.

The foregoing objective of the present invention is attained by the transmission-controlling device, which is composed of a first circuit system, a second circuit system, and a selective switch. The first circuit system is to provide a first voltage. The second circuit system is to provide a second voltage. The selective switch responds to a user's operation to select the first or second voltage to drive the motor so as to change the rotational speed of the motor. Thus, the present invention simplifies and facilitates the switchover of the rotational speed of the motor by employing the selective switch to select the driving voltage for the motor.

### BRIEF DESCRIPTION OF THE DRAWINGS

FIG. 1 is a schematic view of the transmission-controlling device of the present invention.

FIG. 2 is a circuitry view of a first embodiment of the present invention.

FIG. 3 is a circuitry view of a second embodiment of the present invention.

FIG. 4 is a circuitry view of a third embodiment of the present invention.

### DETAILED DESCRIPTION OF EMBODIMENTS

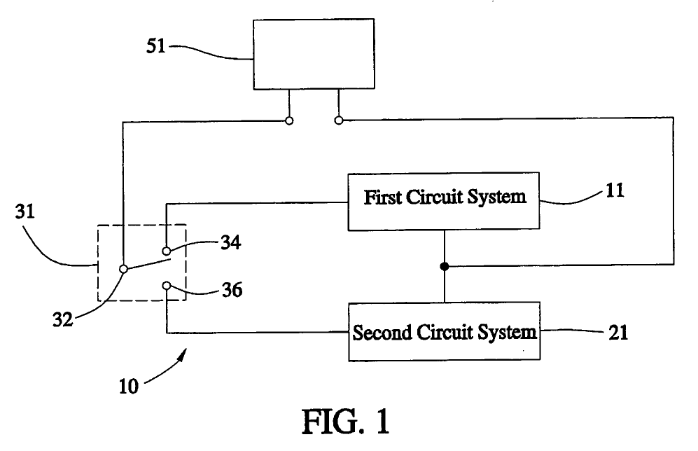

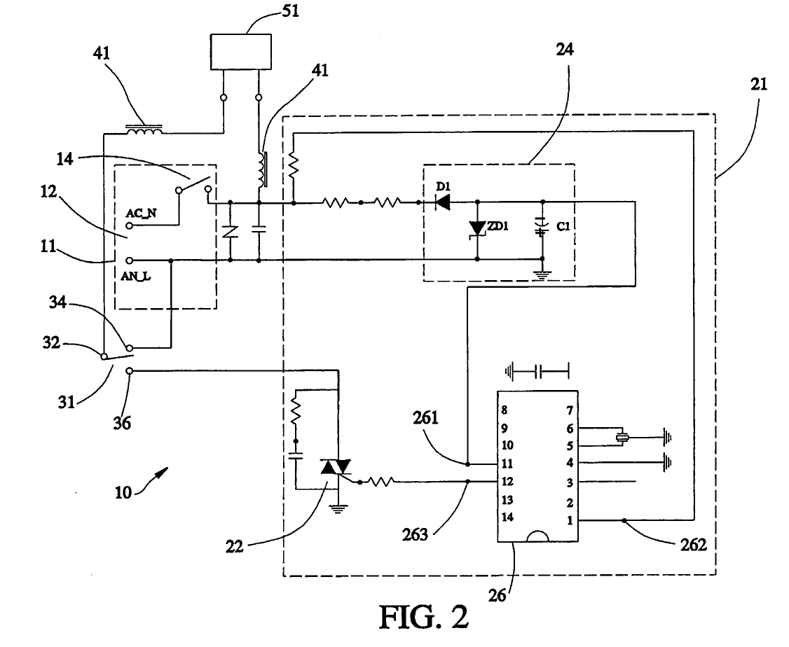

Referring to FIGS. 1-2, a transmission-controlling device 10 for adjusting the rotational speed of a motor 51 is constructed according to a first embodiment of the present invention. The motor 51 is applied to a power tool (not shown), such as a circular saw machine of a cutting machine, and rotates a cutting blade of the power tool to process a workpiece (not shown). The transmission-controlling device 10 includes a first circuit system 11, a second circuit system 21, and a selective switch 31. The first circuit system 11 has an external power source 12 and a starting switch 14, for providing a first voltage. The external power source 12 provides an alternate current (AC). The starting switch 14 is serially connected with the external power source 12. While the starting switch 14 is short-circuit, the external power source 12 provides the first voltage.

The second circuit system 21 includes a power semiconductor device 22, a constant-voltage rectifying circuit 24, and a microprocessor 26, for providing a second voltage which is lower than the first voltage. The power semiconductor device 22 can be a TRIAC (Triode AC Semiconductor Switch) in this embodiment for providing the second voltage. The constant-voltage rectifying circuit 24 has a diode D1 electrically connected with the starting switch 14, a Zener diode ZD1, and a capacitor C1 connected in parallel with the Zener diode ZD1. The constant-voltage rectifying circuit 24 converts the external power source 12 into a direct current (DC) power source while the starting switch 13 is shot-circuit. The DC power source is to provide the microprocessor 26 with an operational voltage for operation of the microprocessor 26. The microprocessor 26, for example, is a programmable controller with Model No. EM78P153S in this embodiment. The microprocessor 26 has a power pin 261 electrically connected with the constant-voltage rectifying circuit 24, an external-power input pin 262 electrically connected with the starting switch 14, and a control pin 263 electrically connected with the power semiconductor device 22. The microprocessor 26 can output a trigger signal for controlling phase according to a predetermined setting relative to the rotational speed of the motor 51 to control a conduction angle of the power semiconductor device 22 and further control the output voltage of the power semiconductor device 22 so as to enable the motor 51 to reach a rotational speed as expected. The selective switch 31 has a common point 32, a first butting point 34, and a second butting point 36. The common point 32 is electrically connected with the motor 51. The first and second butting points 34 and 36 are electrically connected with the external power source 12 and the power semiconductor device 22. The selective switch 31 responds to a user's operation to select the first voltage provided by the external power source 12 or the second voltage provided by the power semiconductor device 22 to drive the motor 51 so as to change the rotational speed of the motor 51.

The transmission-controlling device 10 further includes two choke coils 41. The two choke coils 41 are respectively connected between the common point 32 and the motor 51 and between the starting switch 14 and the motor 51 for wave filtering to protect the motor 51 from affection of high-frequency current.

As indicated above, the present invention conducts the external power source 12 with the starting switch 14 and then selects the rotational speed of the motor 51 with the selective switch 31. While the selective switch 31 is switched to the conduction between the common point 32 and the first butting point 34, the motor 51 is supplied with the first voltage provided by the external power source 12 to run in full rotational speed. While the selective switch 31 is switched to the conduction between the common point 32 and the second butting point 36, the motor 51 is supplied with the second voltage provided by the power semiconductor device 22 to run in lower rotational speed.

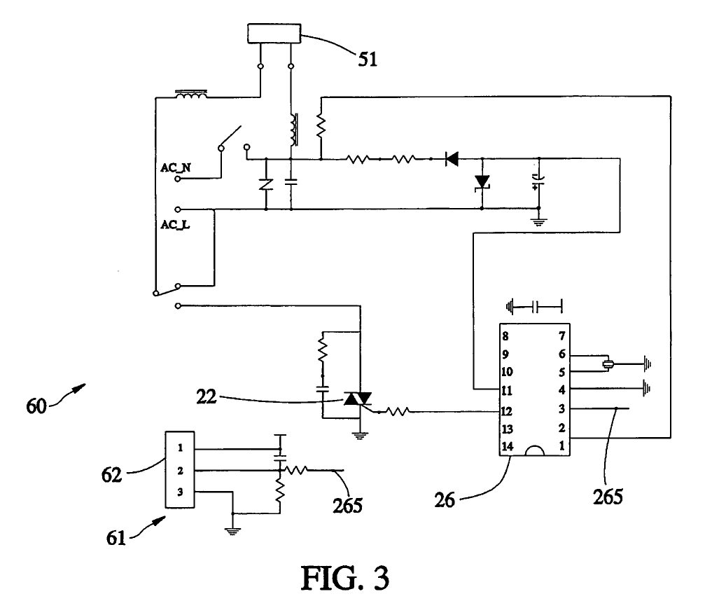

Referring to FIG. 3, a transmission-controlling device 60 constructed according to a second embodiment of the present invention is similar to the transmission-controlling device 10 in the first embodiment, but further includes a speed-sensing circuit 61. A magnetic matter (not shown) is mounted on the motor 51 and is rotatable together with by the motor 51. The speed-sensing circuit 61 is electrically connected with another pin 265 of the microprocessor 26, and has a Hall element 62 which senses the magnetic matter to generate a speed signal corresponding to the rotational speed of the motor 51. The speed-sensing circuit 61 transmits the speed signal to the microprocessor 26 for further processing.

Because the motor 51 rotatably drives the cutting blade of the power tool to process the workpiece, while the cutting blade touches/cuts the workpiece, the rotary speed of the cutting blade is reduced by the resistance generated between the cutting blade and the workpiece and then the rotational speed of the motor 51 is relatedly reduced. In the meantime, the speed-sensing circuit 61 senses the present rotational speed of the motor 51 and transmits the corresponding speed signal to the microprocessor 26; after the speed signal is processed by the microprocessor 26, it can be learned that the rotational speed of the motor 51 is lower than a predetermined speed, such that a driving voltage for the motor 51 has to be increased to enable the rotational speed of the motor 51 to go back to the predetermined speed. At the same time, the microprocessor 26 adjusts the trigger signal and then outputs the adjusted trigger signal to the power semiconductor device 22 for controlling the conduction angle of the power semiconductor device 22 so as to further enhance the second voltage provided by the power semiconductor device 22. Consequentially, the rotational speed of the motor 51 goes back to the predetermined speed as feedback control.

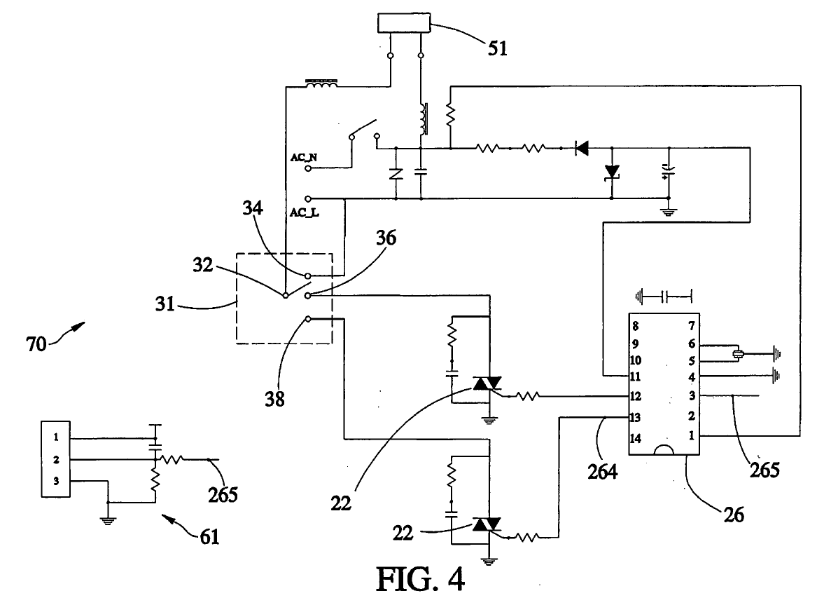

Referring to FIG. 4, a transmission-controlling device 70 constructed according to a third embodiment of the present invention is similar to the transmission-controlling device 10 in the first embodiment, but has difference as recited below.

The transmission-controlling device 70 of the third embodiment employs a plurality of the power semiconductor devices 22 to effect multi-speed transmission of the motor 51. It is to be noted that two power semiconductor devices 22 are taken the third embodiment for example only as recited thereafter and the theorem of their application is the same as that of a plurality of the power semiconductor devices 22. In addition to including one power semiconductor device 22 in the first embodiment, the transmission-controlling device 70 further includes another power semiconductor device 22 electrically connected with another control pin 264 of the microprocessor 26. The microprocessor 26 can output another trigger signal to control the conduction angle of the new power semiconductor device 22. Thus, the two power semiconductor devices 22 are controlled by the microprocessor 26 to provide different voltages. In addition, the selective witch 31 further has third butting point 38 electrically connected with the new power semiconductor device 22.

While the transmission-controlling device 70 is operated, the selective switch 31 is provided to control the rotational speed of the motor 51. While the selective switch 31 is switched to the conduction between the common point 32 and the first/second butting point 34/36, the rotational speed of the motor 51 is as the same as that of the first embodiment. While the selective switch 31 is switched to the conduction between the common point 32 and the third butting point 38, the voltage provided by the power semiconductor device 22 connecting the third butting point 38 is different from the first and second voltage of the first embodiment, such that the motor 51 runs in a rotational speed different from those of the first embodiment. By the means, the motor 51 can be control to effect the multi-speed transmission.

In conclusion, the present invention includes the following advantages:
1. Controllable rotational speed of the motor: The selective switch is employed to select different voltages to be provided for the motor, whereby to control the rotational speed of the motor.
2. Easy switchover and low cost: The present invention provides easy and low-cost switchover of the rotational speed of the motor for the power tool. The conventional rotational speed controlling system is too expensive and complicated for the power tool, such as a circular saw machine, only requiring few change of rotational speed.
3. The feedback control of the rotational speed: The speed-sensing circuit is employed to detect the rotational speed of the motor. While the rotational speed is lower than the predetermined speed, the microprocessor is able to enhance the driving voltage for the motor to keep the rotational speed in the predetermined speed.

The invention has thus been shown and described with reference to the specific embodiments. However, it should be noted that the present invention is in no way limited to the details of the illustrated structures but changes and modifications may be made within the scope of the appended claims.

What is claimed is:

1. A transmission-controlling device for controlling the rotational speed of a motor, comprising:
a first circuit system for providing a first voltage;
a second circuit system for providing a second voltage; and
a selective switch responding to a user's operation to select one of said first and second voltage to drive said motor so as to change the rotational speed of said motor, wherein said motor is adapted to a power tool and rotates a cutting blade of said power tool to process a workpiece.

2. The transmission-controlling device as defined in claim 1, wherein said first circuit system comprises an external power source and a starting switch, said starting switch being serially connected with said external power source, said external power source providing said first voltage while said starting switch is short-circuit.

3. The transmission-controlling device as defined in claim 2, wherein said second voltage is lower than said first voltage.

4. The transmission-controlling device as defined in claim 3, wherein said second circuit system comprises:
at least one power semiconductor device for providing said second voltage;
a constant-voltage rectifying circuit electrically connected with said starting switch, and converting said external power source into an direct current (DC) as said starting switch is short-circuit; and
a microprocessor having a power pin, an external-power input pin, and a control pin, said power pin electrically connected with said constant-voltage rectifying circuit, said external-power input pin electrically connected with said starting switch, said control pin electrically connected with said power semiconductor device, said microprocessor generating a trigger signal for conducting said power semiconductor device.

5. The transmission-controlling device as defined in claim 4, wherein said selective switch comprises a common point and two butting points, said common point electrically connected with said motor, said two butting points electrically connected with said power semiconductor device and said external power source respectively.

6. The transmission-controlling device as defined in claim 5 further comprising two choke coils serially connected between said common point and said motor and between said starting switch and said motor respectively.

7. The transmission-controlling device as defined in claim 4, wherein said constant-voltage rectifying circuit comprises a diode, a Zener diode, and a capacitor, said diode electrically connected with said starting switch, said capacitor connected in parallel with said Zener diode.

8. The transmission-controlling device as defined in claim 4, wherein said microprocessor has a model number of EM78P153S.

9. The transmission-controlling device as defined in claim 4, wherein said power semiconductor device is a TRIAC (Triode AC Semiconductor Switch).

10. The transmission-controlling device as defined in claim 2, wherein said external power source provide an alternate current (AC).

11. The transmission-controlling device as defined in claim 1, wherein said power tool is a cutting machine.

12. The transmission-controlling device as defined in claim 11, wherein said power tool is a circular saw machine.

13. The transmission-controlling device as defined in claim 4, wherein said second circuit system further comprises a speed-sensing circuit for generating a speed signal corresponding to the rotational speed of said motor and then transmitting said speed signal to said microprocessor.

14. The transmission-controlling device as defined in claim 13, wherein said speed-sensing circuit comprises a Hall element.
